(19) United States
(12) Patent Application Publication
(10) Pub. No.: US 2021/0086722 A1
(43) Pub. Date: Mar. 25, 2021

(54) VEHICLE ANTI-THEFT SYSTEM AND DEVICE

(71) Applicant: SOTA SECURITY DEVELOPMENTS PTY LTD., Endeavour Hills, Victoria (AU)

(72) Inventors: Steven John DAVIS, Endeavour Hills, Victoria (AU); Lindsay Vernon HENDERSON, Upwey, Victoria (AU)

(21) Appl. No.: 16/970,643

(22) PCT Filed: Feb. 28, 2019
(86) PCT No.: PCT/AU2019/000024

§ 371 Date: Aug. 18, 2020

(30) Foreign Application Priority Data
Feb. 28, 2018 (AU) 2018900645

(51) Int. Cl. B60R 25/00; B60R 25/40; B60R 25/10; B60R 25/09; B60R 25/102; B60R 25/24

(52) U.S. Cl. CPC B60R 25/001; B60R 25/403; B60R 25/1018; B60R 2325/205; B60R 25/102; B60R 25/241; B60R 2325/103; B60R 25/09

(57) ABSTRACT

The present invention is a vehicle or trailer anti-theft device including electro-mechanical means and a temporary electrical power supply. The temporary electrical power supply acts momentarily upon the electro-mechanical device, thereby causing it to move into an activated condition. In its activated condition, it acts upon either on at least one wheel of the trailer, or the vehicle's parking brake system, to lock the at least one wheel, and remains in its activated condition without the need for any external power supply until such time as the electro-mechanical device is activated or re-connected to the temporary electrical power supply whereby the power supply is able to act momentarily upon the electro-mechanical device, and return said device to its deactivated condition, thereby causing the at least one wheel to be unlocked or the vehicle park brake to deactivate.

### FIELD OF THE INVENTION

This invention relates to vehicles and trailers, or any other type of towable vehicle, and in particular, it relates to a theft deterrent device for use on said vehicles or trailers.

### BACKGROUND OF THE INVENTION

Vehicles and Trailers or other types of towable vehicles are easy to steal. Semi-Trailers, Caravans, Horse Floats, Boat Trailers, Tradie Trailers and the like aren't cheap items, and are attractive targets for thieves. So are the prime movers used to tow them. Towable vehicles in particular are often left standing unattended in driveways, on the street, at storage lots, and at other open areas with easy public access. Theft is comparatively easy because all the thief needs to do is to simply hook the trailer up to a vehicle and drive away. Self-powered vehicles, such as cars, buses, RV, civic construction, and farming equipment such as tractors are also attractive targets for thieves.

There have been several attempts to develop anti-theft devices for use with vehicles and towable vehicles. For example, there are mechanical wheel and/or hitch locks that need to be manually fitted and removed by the owner each time they wish to use the vehicle or trailer. Most of these include a keyed lock and many require special tools to fit and/or remove. However, there has been a proliferation of hand-held battery operated power tools in recent decades, and these are powerful enough to make easy work of cutting and breaking the mechanical device, and thereby defeating them, enabling the vehicle or trailer to be stolen.

Another problem associated with these mechanical anti-theft devices is that they are exposed to the elements and may have parts that permanently reside upon the vehicle or trailer and are therefore affected by dirt and mud and other types of debris, as the vehicle or trailer stands or is moved around. Dirty and/or corroded mechanical devices, or parts thereof, can make it difficult for regular users to use the device. They need constant maintenance and attention in all types of weather, so they remain in an operable condition.

Another type of anti-theft deterrent includes GPS facilities that enable the location of the Vehicle or trailer to be tracked. However, these types of systems are only useful after the vehicle or trailer has been stolen. So, it is therefore not really a deterrent to theft, but is more a means of locating the vehicle or trailer after it has been stolen. Thieves are often able to locate the GPS device and remove it, thereby rendering the technology useless in either theft deterrence, or vehicle or trailer recovery. The GPS signal may also be lost if the vehicle or trailer is moved to a location that has a degraded signal, or if the vehicle or trailer is undercover, and thereby unable to receive a signal from the GPS satellites.

Other types of devices require a constant power supply to keep the anti-theft deterrent activated. This is a major problem if the trailer needs to be stored for prolonged periods of time with no external power connection. Even if a solar sourced power supply is used, it is susceptible to variations in seasonal solar activity. Other events such as snow storms may obscure the solar power collecting panels, thereby degrading their effectiveness or rendering them inoperable. Further to this, the would-be thief may simply obscure the panels ahead of time, or sever the power supply lines coming from the panels to the battery, so that over time the battery is depleted. Or they could sever the power supply lines from the battery to the device.

It is therefore an object of the present invention to provide a vehicle or trailer theft deterrence device that at least ameliorates some of the abovementioned problems.

### DISCLOSURE OF THE INVENTION

Accordingly, in one preferred form, the present invention is a trailer anti-theft device including electro-mechanical means and a temporary electrical power supply. The temporary electrical power supply acts momentarily upon the electro-mechanical device, thereby causing it to move into an activated condition. In its activated condition, it acts upon either on at least one wheel of the trailer, or the tow-hitch, to lock the at least one wheel or tow-hitch, and remains in its activated condition without the need for any external power supply until such time as the electro-mechanical device is activated or re-connected to the temporary electrical power supply whereby the power supply is able to act momentarily upon the electro-mechanical device, and return said device to its deactivated condition, thereby causing the at least one wheel or hitch to become unlocked.

Preferably, the electro-mechanical means is a linear actuator including a shaft that is either extended or retracted when acted upon by a momentary electrical power supply.

Preferably, the linear actuator has the properties where the shaft is retracted and locked in the retracted position in its deactivated condition, and the shaft is extended and locked in its extended position in its activated condition.

In another preferred form, the present invention is an anti-theft system for a trailer including the anti-theft device as previously described, including a sender unit, a logic control means, power connector means, and a prime mover vehicle, wherein the prime mover vehicle includes the power supply for the anti-theft device, and the power supply is connected to the trailer via the power connector means.

In another preferred form, the present invention is an anti-theft system for a trailer including the anti-theft device as defined in any one of claims 1 to 3 including a sender unit, a logic control means, and a power supply, wherein the power supply is installed upon the trailer.

Preferably, the sender unit is capable of remotely sending a signal to the trailer that is received by the logic control means, whereat the signal is checked for authenticity, and once authenticated, the logic control means operates the anti-theft device, causing it to become either activated or deactivated, thereby either locking or unlocking the trailer.

Preferably, the sender unit is either wired or wireless.

Optionally, the sender unit is integrated into the prime mover.

Alternatively, the sender unit is portable, and carried remotely from the trailer, by either a person or persons.

Preferably, the sender unit emits a unique coded signal that is paired with the components of the system that are integrated upon the trailer, so that only specifically paired sender units are capable of activating or deactivating the system.

Optionally, the system includes proximity sensing means that are capable of sensing when a paired sender unit, carried by a person or persons, is moved within a pre-set radius of the trailer, and thereby automatically deactivating the system, or conversely, the proximity sensing means are capable of sensing when a paired sender unit is moved outside a pre-set radius of the trailer, and thereby automatically activating the system.

Preferably, when a remote access request is received by the system from a hand-held device, such as a mobile phone, the system will generate a unique code and transmit said code to an authorised person as an additional layer of security.

Preferably, the system includes tamper detection means that are adapted to detect if any electrical or mechanical cabling related to the device has been tampered with and if a tamper event has been detected, and thereby keeping the device locked.

Preferably, the system includes motion detection means that include G-force and motion sensors and a multi-point verification system, and the motion detection means keeps the system deactivated if the motion detection means detects that the towed vehicle is in motion.

Preferably, the system includes fault detection means that are adapted to detect any mechanical or electrical fault with the system, and if a fault is detected, the system will neither activate nor deactivate, and it will generate an alert that may trigger an alarm, or send an alert text to an authorised person or persons, or both.

Preferably, the motion detection means are also adapted to detect if a person has connected a prime mover to the towable vehicle and if so detected, an alert is generated that is sent as a text to an authorised person or person, or sounds an alarm, or both.

In another preferred form, the present invention is a vehicle anti-theft device that acts upon the vehicle's park brake. The device includes electro-mechanical means that act upon the vehicle's park brake electrical, or hydraulic or pneumatic system. When the electro-mechanical means are temporarily connected to an electrical power supply, the electro-mechanical means is caused to go into its activated condition and thereby activates the park brake. The device remains in its activated condition without the need for any external power supply until such time as the device is activated or re-connected to the electrical power supply whereby the power supply is able to act momentarily upon the electro-mechanical device, and return said device to its deactivated condition, thereby causing the vehicle park brake to be released.

Preferably, the device includes a linear actuator including a shaft that is either extended or retracted when acted upon by a momentary electrical power supply.

Preferably, the linear actuator has the properties where the shaft is retracted and locked in the retracted position in its deactivated condition, and the shaft is extended and locked in its extended position in its activated condition.

In another preferred form, the present invention is an anti-theft system for a vehicle including the anti-theft device as previously described in any one of claims XXX to XXX, including a sender unit, a logic control means, power connector means, wherein the vehicles electrical power supply provides the electrical power to the anti-theft device via the power connector means.

Preferably, the sender unit is capable of remotely sending a signal to the vehicle that is received by the logic control means, whereat the signal is checked for authenticity, and once authenticated, the logic control means operates the anti-theft device, causing it to become either activated or deactivated, thereby either locking or unlocking the park brake on the vehicle.

Preferably, the sender unit is either wired or wireless.

Optionally, the sender unit is integrated into the vehicle.

Alternatively, the sender unit is portable, and carried remotely from the vehicle, by either a person or persons.

Preferably, the sender unit emits a unique coded signal that is paired with the components of the system that are integrated upon the trailer, so that only specifically paired sender units are capable of activating or deactivating the system.

Optionally, the system includes proximity sensing means that are capable of sensing when a paired sender unit, carried by a person or persons, is moved within a pre-set radius of the vehicle, and thereby automatically deactivating the system, or conversely, the proximity sensing means are capable of sensing when a paired sender unit is moved outside a pre-set radius of the vehicle, and thereby automatically activating the system.

Preferably, when a remote access request is received by the system from a hand-held device, such as a mobile phone, the system will generate a unique code and transmit said code to an authorised person as an additional layer of security.

Preferably, the system includes tamper detection means that are adapted to detect if any electrical or mechanical cabling related to the device has been tampered with and if a tamper event has been detected, and thereby keeping the device locked.

Preferably, the system includes motion detection means that include G-force and motion sensors and a multi-point verification system, and the motion detection means keeps the system deactivated if the motion detection means detects that the vehicle is in motion.

Preferably, the motion detection means are also adapted to detect if a person has connected a tow truck or similar to the vehicle and if so detected, an alert is generated that is sent as a text to an authorised person or person, or sounds an alarm on the vehicle, or both.

Preferably, the system includes fault detection means that are adapted to detect any mechanical or electrical fault with the system, and if a fault is detected, the system will neither activate nor deactivate, and it will generate an alert that may trigger an alarm, or send an alert text to an authorised person or persons, or both.

### BRIEF DESCRIPTION OF THE PREFERRED EMBODIMENTS

Some preferred embodiments of the present invention shall now be illustrated in the following drawings:

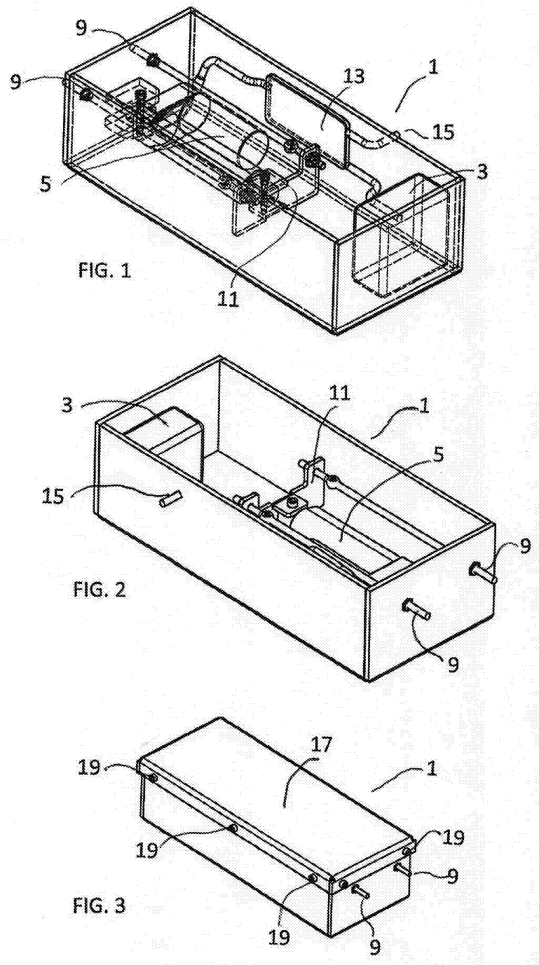

FIG. 1 is an isometric view showing hidden detail of one form of the present invention.

FIG. 2 is an isometric view of the assembly shown in FIG. 1 shown from the opposite end. This time no hidden detail is shown.

FIG. 3 is an isometric view of the assembly shown in FIGS. 1 and 2 with the security lid attached.

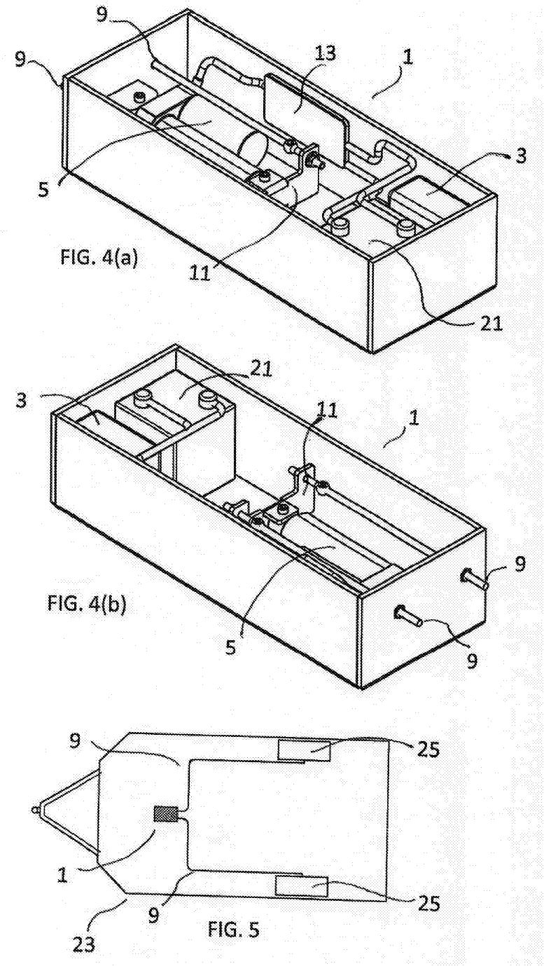

FIGS. 4(a) and (b) show a schematic of another form of the invention, depicting a system where a power supply is included.

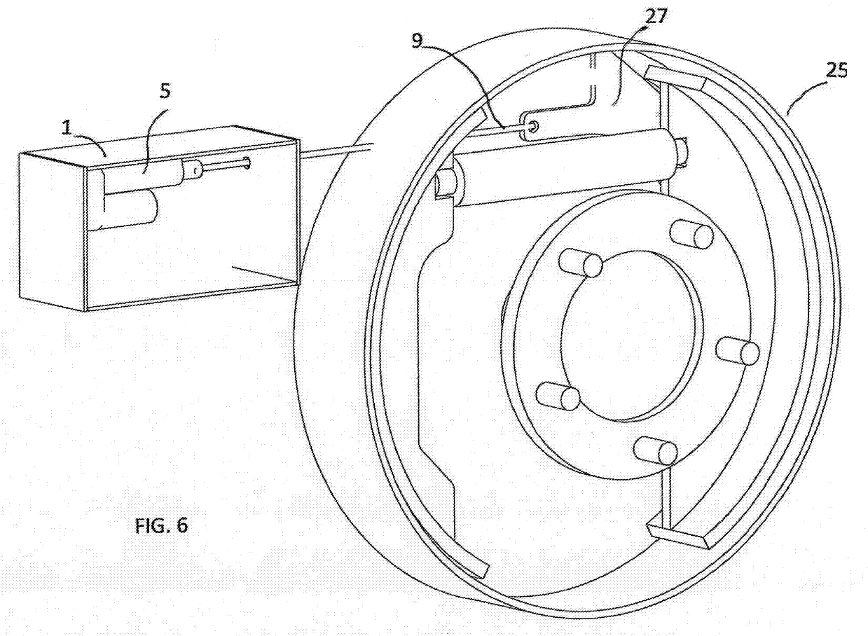

FIG. 5 is a schematic of the installation of the system on a typical trailer. is an alternative embodiment of the assembly that forms a part of the anti-theft system and device.

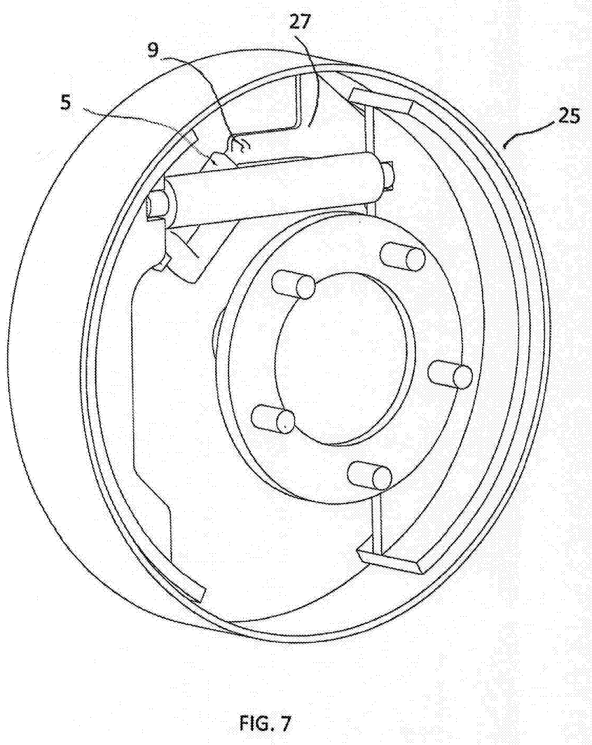

FIG. 6 shows one embodiment of how the system and device acts upon at least one wheel of the trailer.

FIG. 7 shows another embodiment of the present invention and shows how it acts upon at least one wheel of a trailer.

### DESCRIPTION OF THE PREFERRED EMBODIMENTS

Turning firstly to FIGS. 1, 2 and 3 we are shown a variety of views of one form of the main assembly in the present invention. In these views we can see a main security device assembly 1 which contains multiple critical components of the present invention. One such component is a GPS unit 3. This unit is capable of tracking the position of vehicle or trailer in real time. Also included is a linear actuator 5. In this embodiment, a pair of armoured brake cables 9 are shown. Each cable enters the main security device assembly 1 and is attached to a plate 11. An electronic circuit board 13 is also contained within the device assembly 1. The properties of the linear actuator 5 are such that when it is momentarily connected to an electrical power supply, the linear actuator either extends or retracts, and remains in either its extended or retracted position until such time it is momentarily connected to an electrical power supply. When the linear actuator 5 is in its extended position, it has sufficient force to push against the plate 11 and cause it to move away from the actuator 5, thereby pulling on each of the armoured brake cables 9 connected to the plate 11, and thereby activating the brake on the trailer wheel that is connected to each respective brake cable 9. A lid 17 is fastened to the device assembly 1 to securely enclose the assembly. The lid is fastened by a plurality of security fasteners 19. In this embodiment, an external power supply is required to provide the power input through 15. Typically, this is the power supply carried upon the prim mover, such as a car. Alternatively, the power supply can be carried by a user and hooked up when required to either activate or deactivate the invention.

One of the major advantages of the present invention is that the system offers a one-off install solution, which thereby eliminates any need for mechanical fitting or removal of an anti-theft locking device every time the trailer is parked or to be used. The other major advantage is that a constant power supply is not required to keep the trailer secure. The system only requires power to activate and de-activate the system. Once the linear actuator is moved into either its extended or retracted position, it remains locked in that position until it is subjected to another command from the system. In other words, power is not needed to keep the linear actuator either extended or retracted. The advantage of this is that if a would-be thief comes along and thinks that by cutting the wires, then he will disable the system, will find that this has no effect, as once device is locked cutting wires is useless.

Turning to FIGS. 4(a) and (b), we are shown and alternative embodiment of the present invention where the main assembly 1 includes a battery 21. In this variant, no external power supply is required to activate the linear actuator 5. The required power is supplied by the battery 21. This can either be replaced periodically, or alternatively, it may be recharged during operation of the prime mover, vehicle, such as a car.

Turning to FIG. 5, we are shown a simple schematic of the present invention installed on a simply trailer 23. In this embodiment, the main device assembly 1 is securely attached to the trailer, and in this embodiment, a pair of brake cables 9 are used to attach to a park brake assembly on a respective wheel 25. When the system is activated, the parking brake on each respective wheel 25 is activated, thereby preventing the trailer from being towed.

It should be noted that the invention need only work on just one wheel in the trailer.

Tuning to FIG. 6, we are shown one embodiment of the present invention acting upon the parking brake assembly of one wheel assembly 25 of a trailer. Note that only the most essential components are shown for illustrative purposes only. In this embodiment, the device assembly is connected to the parking brake lever plate 27 via armoured brake cable 9. The linear actuator 5 is then capable of activating or deactivating the brake on wheel 25.

Tuning to FIG. 7, we are shown another embodiment of the present invention acting upon the parking brake assembly of one wheel assembly 25 of a trailer. Note that again only the most essential components are shown for illustrative purposes only. In this embodiment, the assembly 1 has been placed inside the wheel assembly 25. The actuator 5 acts upon the park brake lever plate 27 by way of armoured brake cable 9

The system can be made even more convenient by pairing a sender unit with the system installed on the trailer and including proximity sensors. The sender unit could either be a mobile type device that can be carried by a person or persons. It could also be integrated into a prime mover, such as a car or a truck. When the sender unit moves within a pre-set radius of the trailer, the sender unit could link wirelessly to the trailer. This allows for automatic locking and unlocking simply by the proximity of the sender unit to the trailer. The sender unit and the system can be paired together so that only a verified sender unit can pair with the system and enable the user to use the sender unit to command the trailer locking system to either engage or disengage. The sender unit could be a standalone device, or it could simply be an app that is able to be used on a smartphone of other kind of portable computing device, such as a tablet.

Any suitable wireless coded signal could be used within the scope of the present invention, including, but not limited to Radio Frequency, Bluetooth, WIFI, Radar, Ethernet, Cellular telephony signal, Microwave, Magnetic Frequency or by mechanical device such as pushbutton, lever, key switch, pneumatic, hydraulic or electric solenoid.

Battery backup may be used in conjunction with a GPS tracker, GSM modem, Data Logger or recorder. The battery may be re-charged when the trailer is reconnected to the tow vehicle. It is also possible to provide power via solar panels.

Once the trailer is parked in position and is still connected to the tow vehicle, the user can activate the system. Either at least one wheel of the trailer, or the two hitches, or both, then become locked. At this point the trailer can then be unhitched from tow vehicle, and the trailer remains in a locked state, even when the power is disconnected.

To unlock the security system, the power supply on the tow vehicle must first be reconnected to the trailer. The operator can then signal the controller, and the controller then deactivates the locking system. Then the trailer can be moved safely.

In another form of the invention, the system may be integrated into any vehicle, such as a car, or truck, or civic construction vehicle, or farming machinery such as a tractor. The circuitry of the main device, and its outputs can be easily modified to securely activate or deactivate any electronic, pneumatic or hydraulic braking system.

Please note that for the purposes of this specification, all references to a “prime mover” include any form of vehicle used for towing the towed vehicle.

While the above description includes the preferred embodiments of the invention, it is to be understood that many variations, alterations, modifications and/or additions may be introduced into the constructions and arrangements of parts previously described without departing from the essential features or the spirit or ambit of the invention.

It will be also understood that where the word “comprise”, and variations such as “comprises” and “comprising”, are used in this specification, unless the context requires otherwise such use is intended to imply the inclusion of a stated feature or features but is not to be taken as excluding the presence of other feature or features.

The reference to any prior art in this specification is not, and should not be taken as, an acknowledgment or any form of suggestion that such prior art forms part of the common general knowledge.

1. A trailer anti-theft device including electro-mechanical means and a temporary electrical power supply wherein the temporary electrical power supply acts momentarily upon the electro-mechanical device, thereby causing it to move into an activated condition, and wherein in its activated condition, it acts upon either on at least one wheel of the trailer, or the tow-hitch, to lock the at least one wheel or tow-hitch, and remains in its activated condition without the need for any external power supply, until such time as the electro-mechanical device is activated or re-connected to the temporary electrical power supply, whereby the power supply is able to act momentarily upon the electro-mechanical device, and return said device to its deactivated condition, thereby causing the at least one wheel or tow-hitch to become unlocked.

2. The anti-theft device as defined in claim 1 wherein the electro-mechanical device is a linear actuator including a shaft that is either extended or retracted when acted upon by the temporary electrical power supply.

3. The anti-theft device as defined in claim 2 wherein the linear actuator has the properties where the shaft is retracted and locked in the retracted position in its deactivated condition, and the shaft is extended and locked in its extended position when in its activated condition.

4. An anti-theft system for a trailer including the anti-theft device as defined in claim 3 including a sender unit, a logic control means, power connector means, and a prime mover vehicle, wherein either the prime mover vehicle includes the electrical power supply for the anti-theft device, and the power supply is connected to the trailer via the power connector means, or the power supply is installed directly upon the trailer.

5. (canceled)

6. The anti-theft system as defined in claim 4 wherein the sender unit is capable of remotely sending a signal to the trailer that is received by the logic control means, whereat the signal is checked for authenticity, and once authenticated, the logic control means operates the anti-theft device, causing it to become either activated or deactivated, thereby either locking or unlocking the trailer.

7. The anti-theft system as defined in claim 5 wherein the sender unit is either wired or wireless and is either integrated in the prime mover or is adapted to be carried remotely from the trailer by either a person or persons.

8. (canceled)

9. (canceled)

10. The anti-theft system as defined in either claim 6 wherein the sender unit emits a unique coded signal that is paired with the components of the system that are integrated upon the trailer, so that only specifically paired sender units are capable of activating or deactivating the system.

11. The anti-theft system as defined in claim 7 wherein the system includes proximity sensing means that are capable of sensing when a paired sender unit, carried by a person or persons, is moved within a pre-set radius of the trailer, and thereby automatically deactivating the system, or conversely, the proximity sensing means are capable of sensing when a paired sender unit is moved outside a pre-set radius of the trailers, and thereby automatically activating the system.

12. The anti-theft system as defined in claim 7 wherein when a remote access request is received by the system from a hand-held device, such as a mobile phone, the system will generate a unique code and transmit said code to an authorised person as an additional layer of security.

13. The anti-theft system as defined in claim 9 wherein the system includes tamper detection means that are adapted to detect if any electrical or mechanical cabling related to the device has been tampered with and if a tamper event has been detected, thereby keeping the device locked.

14. The anti-theft system as defined in claim 10 wherein the system includes motion detection means that include G-force and motion sensors and a multi-point verification system, and the motion detection means keeps the system deactivated if the motion detection means detects that the towed vehicle is in motion, and wherein the motion detection means are also adapted to detect if a person has connected a prime mover to the towable vehicle and if so detected, an alert is generated that is sent as a text to an authorised person or person, or sounds an alarm, or both.

15. (canceled)

16. The anti-theft system as defined in claim 11 wherein the system includes fault detection means that are adapted to detect any mechanical or electrical fault with the system, and if a fault is detected, the system will neither activate nor deactivate, and it will generate an alert that may trigger an alarm, or send an alert text to an authorised person or persons, or both.

17. A vehicle anti-theft device that acts upon the vehicle's park brake wherein the device includes electro-mechanical means that act upon the vehicle's park brake electrical, or hydraulic or pneumatic system, and wherein the electro-mechanical means are temporarily connected to an electrical power supply, the electro-mechanical means is caused to go into its activated condition and thereby activates the park brake, and wherein the device remains in its activated condition without the need for any external power supply until such time as the device is activated or re-connected to the electrical power supply whereby the power supply is able to act momentarily upon the electro-mechanical device, and return said device to its deactivated condition, thereby causing the vehicle park brake to be released.

18. The vehicle anti-theft device as defined in claim 13 wherein the device includes a linear actuator including a shaft that is either extended or retracted when acted upon by a momentary electrical power supply.

19.-31. (canceled)

32. The vehicle anti-theft device as defined in claim 14 wherein the linear actuator has the properties where the shaft is retracted and locked in the retracted position in its deactivated condition, and the shaft is extended and locked in its extended position in its activated condition.

33. An anti-theft system for a vehicle including the anti-theft device as defined in claim 15 including a sender unit, a logic control means, power connector means, wherein the vehicle's electrical power supply provides the electrical power to the anti-theft device via the power connector means.

34. The anti-theft system as defined in claim 16 wherein the sender unit is capable of remotely sending a signal to the vehicle that is received by the logic control means, whereat the signal is checked for authenticity, and once authenticated, the logic control means operates the anti-theft device, causing it to become either activated or deactivated, thereby either locking or unlocking the park brake on the vehicle.

35. The anti-theft system as defined in claim 17 wherein the sender unit is either wired or wireless.

36. The anti-theft system as defined in claim 18 wherein the sender unit is integrated into the vehicle, or the sender unit is portable, and is carried remotely from the vehicle, by either a person or persons.

37. The anti-theft system as defined in claim 19 wherein the sender unit emits a unique coded signal that is paired with the components of the system that are integrated upon the trailer, so that only specifically paired sender units are capable of activating or deactivating the system.

38. The anti-theft system as defined in claim 19 wherein the system includes proximity sensing means that are capable of sensing when a paired sender unit, carried by a person or persons, is moved within a pre-set radius of the vehicle, and thereby automatically deactivating the system, or conversely, the proximity sensing means are capable of sensing when a paired sender unit is moved outside a pre-set radius of the vehicle, and thereby automatically activating the system.

39. The anti-theft system as defined in claim 20 wherein when a remote access request is received by the system from a hand-held device, such as a mobile phone, the system will generate a unique code and transmit said code to an authorised person as an additional layer of security.

40. The anti-theft system as defined in claim 22 wherein the system includes tamper detection means that are adapted to detect if any electrical or mechanical cabling related to the device has been tampered with and if a tamper event has been detected, and thereby keeping the device locked.

41. The anti-theft system as defined in claim 23 wherein the system includes motion detection means that include G-force and motion sensors and a multi-point verification system, and the motion detection means keeps the system deactivated if the motion detection means detects that the vehicle is in motion.

42. The anti-theft system as defined in claim 24 wherein the motion detection means are also adapted to detect if a person has connected a tow truck or similar to the vehicle and if so detected, an alert is generated that is sent as a text to an authorised person or person, or sounds an alarm on the vehicle, or both.

43. The anti-theft system as defined in claim 25 wherein the system includes fault detection means that are adapted to detect any mechanical or electrical fault with the system, and if a fault is detected, the system will neither activate nor deactivate, and it will generate an alert that may trigger an alarm, or send an alert text to an authorised person or persons, or both.
